(19) United States
(12) Patent Application Publication
(10) Pub. No.: US 2006/0138935 A1
(43) Pub. Date: Jun. 29, 2006

(54) Field emission lamp and backlight module using same

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/303,357

(22) Filed: Dec. 16, 2005

(30) Foreign Application Priority Data
Dec. 25, 2004 (CN) 200410091894.6

(51) Int. Cl. H01J 1/62

(52) U.S. Cl. 313/496

(57) ABSTRACT

A field emission lamp includes a substrate, conductive cathode, insulating layer, plurality of emitters, transparent anode, and fluorescent layer. The conductive cathode is formed on the substrate. Each emitter includes a base section and tip section, the tip section being disposed on the corresponding base section. The base sections of the emitters and the insulating layer are integrally created on the conductive cathode. The emitters are perpendicular to the insulating layer. The transparent anode is spaced apart from the emitters. The fluorescent layer is deposited on a surface of the transparent anode and faces to the emitters. Advantageously, the base sections and the insulating layer are made of diamond-like carbon, and the tip section is made of niobium. The field emission lamp has a long life expectancy and an excellent luminescence. This field emission lamp can be used in a backlight module.

### BACKGROUND OF THE INVENTION

1. Field of the Invention

The present invention relates to field emission lamps and, particularly, to a field emission lamp and backlight module for use in, e.g., a liquid crystal display (LCD).

2. Discussion of the Related Art

In a liquid crystal display device, liquid crystal is a substance that does not itself radiate light. Instead, the liquid crystal relies on receiving light from a light source, thereby displaying images and data. In the case of a typical liquid crystal display device, a backlight module powered by electricity supplies the needed light.

Conventional light sources used in the backlight modules generally include light emitting diodes (LEDs), cold cathode fluorescent lamps (CCFLs), incandescent lamps, metallic halide lamps, high intensity discharge lamps (HIDLs), and so on. Presently, only the LEDs and CCFLs have been widely used as light sources in the backlight modules of the liquid crystal displays. However, an LED has a shortcoming of low luminous efficiency. A CCFL generally employs mercury vapor. When a CCFL in use, electrons are accelerated by an electric field and then collide with the mercury vapor. This collision causes excitation of the mercury vapor and subsequent remission. The remission process causes radiation of ultraviolet rays. The ultraviolet rays irradiate a fluorescent material of the lamp, whereby the ultraviolet rays are converted into visible light.

However, the mercury vapor is toxic to humans and environmentally unsafe. Therefore, in recent years, field emission lamps which adopt carbon nanotubes as emitters have been manufactured to replace conventional luminescent lamps.

Referring to FIG. 4 (Prior art), a conventional field emission lamp 5 which adopts carbon nanotubes as emitters is shown. The field emission lamp 5 includes a lower substrate 10, a metal film 11, a conductive polymer film pattern 12, a plurality of carbon nanotubes 15, a fluorescent layer 16, a transparent anode 17, a transparent upper substrate 18, and a plurality of spacers 19.

The metal film 11 is formed on the lower substrate 10 and serves as a cathode. The conductive polymer film pattern 12 is formed on the metal film 11. Each carbon nanotube 15 has one end bound with the conductive polymer film pattern 12, while the other end thereof extends substantially perpendicularly from and beyond the conductive polymer film pattern 12. The carbon nanotubes 15 are used as emitters for emitting electrons. The transparent upper substrate 18 is spaced apart from the carbon nanotubes 15. The transparent anode 17 is formed on a surface of the transparent upper substrate 18 and faces to the carbon nanotubes 15. The fluorescent layer 16 is formed on the transparent anode 17. The spacers 19 are arranged on the metal film 11 for supporting the transparent upper substrate 18. The field emission lamp 5 can obtain a large emission current under a relatively low voltage, by using the carbon nanotubes 15. In addition, the field emission lamp 5 exhibits excellent luminous efficiency because a very high distribution density of the nanotube tips per unit area can be readily achieved.

However, the carbon nanotubes 15 may be potentially easily twisted by a strong electric field applied thereto, between the transparent anode 17 and the metal film 11. In addition, because the carbon nanotubes 15 are bound to the conductive polymer film pattern 12 by hardening the conductive polymer film pattern, the carbon nanotubes 15 are liable to break away from the conductive polymer film pattern 12 during the field emission process. In summary, the field emission lamp 5 tends to have a relatively short service life by using the carbon nanotubes 15 as emitters.

What is needed, therefore, is a field emission lamp which has a long service life.

### SUMMARY

A field emission lamp according to a preferred embodiment includes a substrate, a conductive cathode, an insulating layer, a plurality of emitters, a transparent anode, and a fluorescent layer. The conductive cathode is applied on the substrate. Each emitter includes a base section and a tip section is created on the base section. The base sections of the emitters and the insulating layer are integrally formed on the conductive cathode. The transparent anode is spaced apart from the emitters. The fluorescent layer is formed on a surface of the transparent anode and faces the emitters. The base section is advantageously made of diamond-like carbon (DLC) and the tip section is advantageously made of niobium.

A backlight module according to a preferred embodiment includes a light guide device and a field emission lamp. The light guide device includes an incident surface and an emitting surface adjacent to the incident surface. The field emission lamp is disposed adjacent to the incident surface of the light guide device. The field emission lamp includes a substrate, a conductive cathode, an insulating layer, a plurality of emitters, a transparent anode, and a fluorescent layer. The conductive cathode is formed on the substrate. Each emitter includes a base section and a tip section is created on the base section. The base sections of the emitters and the insulating layer are integrally created on the conductive cathode. The transparent anode is spaced apart from the emitters. The fluorescent layer is deposited on a surface of the transparent anode and faces to the emitters. The base section is made of DLC and the tip section is made of niobium.

Compared with a conventional field emission lamp, the preferred field emission lamp has a plurality of emitters including a base section and a tip section. The base section is formed of DLC and the tip section is formed of niobium. The emitters, as individual units, not only have excellent field emission capability but also have good mechanical strength and a good Young's modulus (i.e., sufficient elasticity). Thus, such emitters may not be readily twisted to the point of fracture/breaking by the strong electric field applied thereto by the transparent anode and the conductive cathode. In addition, because the insulating layer and the base section of the emitters are integrally formed on the conductive cathode, the emitters have a good interconnection strength with the insulating layer and thus avoid being broken away therefrom, thereby generally prolonging the service life thereof. Furthermore, a very high distribution density of tips of the emitters can be achieved, and, thus, the luminous efficiency associated therewith is improved, on the whole.

Other advantages and novel features will become more apparent from the following detailed description of preferred embodiments when taken in conjunction with the accompanying drawings.

### BRIEF DESCRIPTION OF THE DRAWINGS

Many aspects of the field emission lamp and the related backlight module having the same can be better understood with reference to the following drawings. The components in the drawings are not necessarily to scale, the emphasis instead being placed upon clearly illustrating the principles of the present field emission lamp and the related backlight module. Moreover, in the drawings, like reference numerals designate corresponding parts throughout the several views.

FIG. 1 is a schematic, cross-sectional view of a field emission lamp, according to a first preferred embodiment;

FIG. 2 is an enlarged view of a circled portion II of FIG. 1;

FIG. 3 is a schematic perspective view of a backlight module, employing the field emission lamp of FIG. 1, according to a second preferred embodiment; and

FIG. 4 is a schematic sectional view of a conventional field emission lamp.

### DETAILED DESCRIPTION OF THE PREFERRED EMBODIMENTS

Reference will now be made to the drawings to describe preferred embodiments of the present field emission lamp and the related backlight module, in detail.

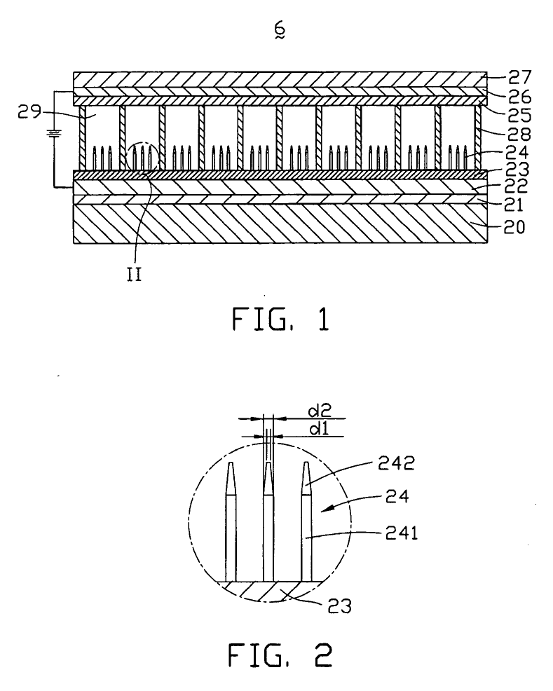

Referring to FIG. 1 and FIG. 2, a field emission lamp 6, in accordance with a first embodiment, is shown. The field emission lamp 6 includes a lower substrate 20, a nucleation layer 21, a conductive cathode 22, an insulating layer 23, a plurality of emitters 24, a fluorescent layer 25, a transparent anode 26, a transparent upper substrate 27, and a plurality of spacers 28.

The nucleation layer 21 is created on the lower substrate 20. The conductive layer 22 is generated on the nucleation layer 21. Each of the emitters 24 has a solid body that includes a base section 241 and a tip section 242, the tip section being produced on the base section 241 (see FIG. 2). The base section 241 of the emitters 24 and the insulating (i.e., dielectric) layer 23 are integrally patterned on the conductive cathode 22. The base sections 241 of the emitters 24 are substantially perpendicular to the insulating layer 23 and are arranged in a predetermined pattern. The transparent upper substrate 27 is spaced apart from the emitters 24. The transparent anode 26 is applied or coated on a surface of the transparent upper substrate 27 and faces the emitters 24. The fluorescent layer 25 is fabricated on a surface of the transparent anode 26. The spacers 28 are disposed on the insulation layer 23, corresponding to the predetermined pattern of the emitters 24. The transparent anode 26 and the fluorescent layer 25 are sequentially stacked one on another on the transparent upper substrate 27. The spacers 28 are interposed between the upper substrate 27 and the lower substrate 20. An inner vacuum chamber 29 is formed between the upper substrate 27 and the lower substrate 20.

Referring also FIG. 2, a set of the emitters 24 are shown, via an enlarged view. The base sections 241 of the emitters 24 are integrally connected with the insulating layer 23. Specifically, each base section 241 of the emitters 24 and the insulating layer 23 is formed of the same material (e.g., DLC), and no discernable boundary exists at the junction between each base section 241 and the insulating layer 23. The insulating layer 23 and the DLC base 241, by being formed of a dielectric material (i.e., DLC), provide a steady electric potential difference to the emitters, thereby decreasing the turn-on voltage. The respective tip sections 242 of the emitters 24 project toward the fluorescent layer 25. The shape of the base section 241 is substantially a cylinder. A height of the base section 241 is configured to be about in the range from 100 to 2000 nanometers. A diameter of the base section 241 is configured to be in the approximate range from 10 to 100 nanometers.

The tip section 242 is substantially in a form of a frustum of a cone having a base diameter d1 and a tip diameter d2. The base diameter d1 of the tip section 242 is approximately the same as the diameter of the base section 241. A height of the tip section 242 is configured to be about in the range from 10 to 200 nanometers. A base diameter d1 of the tip section 242 is configured to be in the approximate range from 10 to 100 nanometers. A tip diameter d2 of the tip section 242 is configured to be in the range of about from 0.5 to 10 nanometers. A material of the tip section 242 is an emissive metal, providing both good mechanical and emissive qualities, and advantageously is niobium, in particular.

The lower substrate 20 is formed of a dielectric material which is selected, e.g., from the group consisting of silicon (Si), alumina (Al₂O₃), quartz, or glass. It is preferable that the lower substrate 20 is formed of a glass, which is suitable for a sealing process, allowing evacuation and completion of a field emission lamp 6. The insulating layer 23 is advantageously formed of DLC and thereby efficiently acts as a dielectric/capacitor layer, providing a steady charge to the emitters 24. The nucleation layer 21 is a thin film with a thickness thereof being configured to be about 1 nanometer. A material of the nucleation layer 21 may be selected, advantageously, from the group consisting of silicon (Si), a silicon and sliver mixture (Si—Ag), and a silicon and gold mixture (Si—Au). The nucleation layer 21 is provided for facilitating the depositing of the conductive cathode 22 on the lower substrate 20. However, the nucleation layer 21 is optional and can be omitted. A material of the conductive cathode 22 may be selected, for example, from the group of consisting of copper (Cu), silver (Ag), and gold (Au), and mixtures of such metals. Such metals are advantageous as they are highly conductive and oxidation resistant.

The transparent upper substrate 27 is made of glass or, potentially, a clear plastic. The transparent anode 26 is constituted of a transparent conductive material, such as indium tin oxide (ITO). The fluorescent layer 25 is advantageously composed of a fluorescent material, for example, (3Ca₃(PO₄)₂CaFCl/Sb,Mn), which is capable of generating a white luminescence, or a combination of fluorescent materials including, for example, (Y₂O₃:Eu), (CeMaA₁₁O₁₉:Tb) and (BaMg₂Al₁₆O₇:Eu), to generate a white luminescence based on the three combined emission spectrums. It is to be understood, within the scope of the present field emission lamp, that the fluorescent layer 25 could instead be designed to produce light of a color other than white.

A preferred method for making the emitters 24, with the insulating layer 23 being formed on the conductive cathode layer 22, includes the steps of:
A) forming a DLC layer on the conductive cathode layer 22 by a sputtering process or a depositing process;
B) creating a niobium layer on the DLC layer by a sputtering process;
C) chemically etching the DLC layer and the niobium layer in a predetermined pattern, thereby obtaining the insulating layer 23 and the emitters 24, each emitter 24 being composed of a respective base section 241 and a respective tip section 242.

In use, an electric field is applied to the transparent anode 26 and the conductive cathode 22. Due to the electric field concentrated around the tip sections 242 of the emitters 24, electrons are emitted from the tip sections 242 of the emitters 24. The emitted electrons are accelerated and then collide with the fluorescent layer 25, whereby the fluorescent layer 25 is excited and radiates light therefrom.

The DLC base section 241 and the niobium tip section 242 not only combine to provide excellent field emission capability, but also have good mechanical strength and a good Young's modulus. Thus, the emitters 24 may not be readily twisted to the point of fracture by the strong electric field applied thereto by the transparent anode 26 and the conductive cathode 22. In addition, because the insulating layer 23 and the base section 241 of the emitters are integrally formed on the conductive cathode 22, the emitters 24 have a good mechanical strength adjacent the insulating layer 23 and, thus, resist breaking away from the insulating layer 23, thereby prolonging the service life thereof. Furthermore, a very high distribution density of tips of the emitters 24 can be achieved and, accordingly, the luminous efficiency associated therewith should, expectedly, be improved.

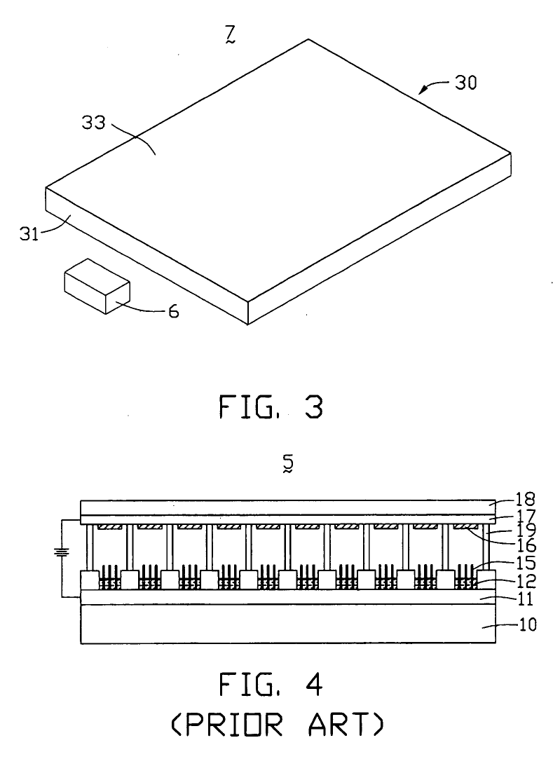

Referring to FIG. 3, a backlight module 7 using the field emission lamp 6, in accordance with a second embodiment, is shown. The backlight module 7 includes the field emission lamp 6 and a light guide plate 30. The light guide plate 30 is generally a flat sheet, which includes an incident surface 31 and an emitting surface 33 adjoining the incident surface 31. The field emission lamp 6 is disposed adjacent the incident surface 31 of the light guide plate 30. It is to be understood that the light guide plate 30 can be selected from any conventional light guide plates. The backlight module 7 using the field emission lamp 6 can improve brightness. The use of the field emission lamp 6 with the backlight module 7 represents only one of the several potential uses thereof, and it is to be understood that the field emission lamp 6 may potentially be employed in any of a variety of situations in which a light source is needed.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A field emission lamp, comprising:
a substrate;
a conductive cathode formed on the substrate;
an insulating layer comprised of a dielectric material;
a plurality of emitters, each emitter including a base section and a tip section formed on the corresponding base section, the base section of each of the emitters and the insulating layer being integrally created on the conductive cathode, each base section and the insulating layer being comprised of the same dielectric material, the tip section being comprised of an emissive metal;
a transparent anode spaced apart from the emitters; and
a fluorescent layer provided on a surface of the transparent anode and facing toward the emitters.

2. The field emission lamp according to claim 1, wherein each emitter is substantially perpendicular to the insulating layer.

3. The field emission lamp according to claim 1, wherein the base section of each emitter is in a form of cylinder.

4. The field emission lamp according to claim 3, wherein a height of the base section of each emitter is in an approximate range from 100 to 2000 nanometers.

5. The field emission lamp according to claim 3, wherein a diameter of the base section of each emitter is about in the range from 10 to 100 nanometers.

6. The field emission lamp according to claim 1, wherein the tip section of each emitter is substantially in a form of a frustum of a cone.

7. The field emission lamp according to claim 6, wherein a height of the tip section of each emitter is approximately in the range from 10 to 200 nanometers.

8. The field emission lamp according to claim 6, wherein the tip section has a base diameter and a tip diameter, the tip diameter being about in the range from 0.5 to 10 nanometers.

9. The field emission lamp according to claim 1, further comprising a nucleation layer located between the substrate and the conductive cathode, the nucleation layer being configured for facilitating the creation of the conductive cathode.

10. The field emission lamp according to claim 1, wherein the tip section is comprised of niobium.

11. The field emission lamp according to claim 1, further comprising a transparent upper substrate formed on the transparent anode.

12. The field emission lamp according to claim 1, wherein the substrate is comprised of a material selected from the group consisting of silicon, alumina, quartz and glass, the conductive cathode being comprised of a material selected from the group consisting of copper, silver, and gold.

13. The field emission lamp according to claim 1, wherein the insulating layer and each base section are each comprised of diamond-like carbon.

14. A backlight module comprising:
a light guide device, including:
an incident surface; and
an emitting surface adjacent to the incident surface; and
a field emission lamp disposed adjacent to the incident surface, the field emission lamp including:
a substrate;
a conductive cathode formed on the substrate;
an insulating layer comprised of a dielectric material;
a plurality of emitters, each emitter including a base section and a tip section formed on the corresponding base section, the base section of each of the emitters and the insulating layer being integrally created on the conductive cathode, each base section and the insulating layer being comprised of the same dielectric material, the tip section being comprised of an emissive metal;
a transparent anode spaced apart from the emitters; and
a fluorescent layer provided on a surface of the transparent anode and facing to the emitters.

15. The backlight module according to claim 14, wherein each emitter is substantially perpendicular to the insulating layer.

16. The backlight module according to claim 14, wherein the base section of each emitter is in a form of cylinder.

17. The backlight module according to claim 14, wherein the tip section of each emitter is in a form of a substantially frustum of a cone.

18. The backlight module according to claim 14, wherein the tip section of each emitter is comprised of niobium, the insulating layer and each base section being each comprised of diamond-like carbon
